(19) United States
(12) Patent Application Publication
(10) Pub. No.: US 2010/0050193 A1
(43) Pub. Date: Feb. 25, 2010

(54) RECORDING DEVICE

(75) Inventors: Tomoya TAKIKAWA, Shiojiri-shi (JP); Shintaro KOMURO, Shiojiri-shi (JP); Yoshiaki SHIBASAKI, Azumino-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/545,559

(22) Filed: Aug. 21, 2009

(30) Foreign Application Priority Data
Aug. 22, 2008 (JP) 2008-213652

(51) Int. Cl. G11B 17/04

(52) U.S. Cl. 720/601; G9B/17.013

(57) ABSTRACT

Provided is a recording device including: a holding tray which is reciprocally transported to a set position for setting a recordable material and another position; a transport roller which applies transport force to the holding tray; and a wrong insertion preventive member of the recordable material, which is provided so as to advance into or retract from the holding tray in a region facing a surface of the holding tray, on which the recordable material is set, when the holding tray is positioned at the set position.

### BACKGROUND

1. Technical Field

The present invention relates to a recording device, such as a printer, a facsimile machine or a copier, including a holding tray used when recording is performed with respect to a hard recordable material.

2. Related Art

Hereinafter, for example, an ink jet printer which is an example of a recording device will be described. As an example of an ink jet printer, there is an ink jet printer capable of selectively performing recording with respect to both a soft recordable material having no self-standing, such as paper or a film, and a hard recordable material having self-standing, such as an optical disc (a CD-R, a DVD-R or the like). In addition, when recording is performed with the hard recordable material, an ink jet printer having a structure in which a dedicated long holding tray which is prepared as a separate accessory part is used or a holding tray which is built in a printer body as disclosed in JP-A-2005-59584 is used. A set concave portion for setting a recordable material, such as a CD-R, is provided in the holding tray.

However, the upper surface of the holding tray is entirely formed of a substantially flat surface, and the set concave portion is also formed of a shallow bottom. Accordingly, when a user sets a recordable material, such as a CD-R, toward the set concave portion of the shallow bottom formed in the upper surface of the holding tray, the recordable material may not be accurately set in the set concave portion. In this case, when the recordable material such as the CD-R is erroneously inserted into the device body or is used in a state of being projected from the set concave portion, it may lead to the damage of the CD-R or the failure of the recording device.

In particular, in the ink jet printer having the structure in which the holding tray is built, the holding tray may not be pulled out to a position in which the CD-R can be set from a just upper portion thereof, due to the structure thereof. That is, a portion of the holding tray positioned at a set position is mainly hidden in the printer body. Accordingly, in the set operation of the CD-R in the set concave portion, since the holding tray of which the portion is hidden is inserted into the printer body toward the set concave portion by a half portion from the oblique front side of the holding tray positioned at the set position, the possibility that the CD-R is not accurately set in the set concave portion is higher.

### SUMMARY

An advantage of some aspects of the invention is that it provides a recording device capable of preventing wrong insertion into a device body when a recordable material such as a CD-R is set in a set concave portion of a holding tray.

According to an aspect of the invention, there is provided a recording device including: a holding tray which is reciprocally transported so as to be positioned at a set position for setting a recordable material and another position; a transport roller which applies transport force to the holding tray; and a wrong insertion preventive member of the recordable material, which is provided so as to advance into or retract from the holding tray in a region facing a surface of the holding tray, on which the recordable material is set, when the holding tray is positioned at the set position.

According to this aspect, when a hard recordable material such as an optical disk is set in the holding tray, the wrong insertion preventive member advances to the holding tray side so as to prevent the recordable material from advancing into the device body.

The recording device may further include an ejection roller including an ejection driving roller and an ejection driven roller and applying ejection force to another recordable material after recording; a support frame which rotatably supports the ejection driven roller; and a release mechanism which moves the support frame to a nip position in which the ejection driven roller is brought into contact with the ejection driving roller and a release position in which the ejection driven roller is separated from the ejection driving roller, and the wrong insertion preventive member may be in a retreated state when the support frame is positioned at the nip position and may be in an advanced state when the support frame is positioned at the release position, interlocking with the operation of the release mechanism.

According to this aspect, it is possible to switch the retreated state and the advanced state of the wrong insertion preventive member interlocking with the movement between the nip position and the release position of the support frame in the release mechanism. When the support frame is positioned at the nip position, the wrong insertion preventive member is in the retreated state and thus a soft recordable material which is another recordable material can be smoothly transported. In contrast, when the support frame is positioned at the release position, the wrong insertion preventive member is in the advanced state and thus the wrong insertion of the hard recordable material into the device body is prevented.

In the recording device, the wrong insertion preventive member may include a flap which is rotatably mounted in the support frame by a cam mechanism, and the cam mechanism may be interlocked with the operation of the release mechanism such that the flap is in a retreated attitude when the support frame is positioned at the nip position and is in an advanced attitude when the support frame is positioned at the release position.

According to this aspect, since the wrong insertion preventive member is configured by the flap which is rotatably mounted in the support frame by the cam mechanism, it is possible to switch the retreated state and the advanced state interlocking with the release mechanism using a simple structure.

In the recording device, an engaging receptacle engaged with the wrong insertion preventive member in the advanced state may be provided in the holding tray, when the holding tray is positioned at the set position.

According to this aspect, since the wrong insertion preventive member in the advanced state is engaged with the engaging receptacle of the holding tray, the advanced state of the wrong insertion preventive member is stabilized and the gap between the wrong insertion preventive member and the holding tray is removed. Thus, the wrong insertion of the hard recordable material into the device body is prevented with certainty.

In the recording device, the wrong insertion preventive member may include a flap which advances into and retreats from the holding tray by rotation, and the flap may be energized such that a rotation attitude associated with the advanced state is held and is configured so as to be rotated using the attitude as a neutral point.

According to this aspect, when the holding tray is positioned at the set position, the rotation of the wrong insertion preventive member functioning as the flap engaged with the engaging receptacle is regulated by the holding tray and thus the wrong insertion of the hard recordable material into the device body is prevented. In addition, when the holding tray positioned at the set position starts to be moved toward a recording start position, when the holding tray is moved from the recording start position to the set position, or when the holding tray is moved from a storage position to arrive at the set position, the flap is brought into slidable contact with the holding tray against the energizing force of the energizing member and is rotated in a transport direction or a return direction. Accordingly, it is possible to smoothly transport the holding tray and the hard recordable material set in the holding tray.

In the recording device, the flap may include a first protrusion provided in a passage region of the recordable material set in the holding tray and a second protrusion provided outside the passage region of the recordable material, and the flap may be tilted from the neutral point by the contact between the holding tray and the second protrusion such that the first protrusion is separated from the recordable material.

The flap may be tilted from the neutral point by the contact between the holding tray and the second protrusion, by the structure in which the protrusion dimension of the second protrusion is longer than that of the first protrusion or the structure in which the protrusion dimensions of the second protrusion and the first protrusion are equal but the portion of the holding tray corresponding to the second protrusion is high.

According to this aspect, since the first protrusion is configured so as to be separated from the recordable material by tilting the flap from the neutral point by the contact between the holding tray and the second protrusion, only the second protrusion outside the passage region is brought into slidable contact with the holding tray and the first protrusion in the passage region is not brought into contact with the holding tray and the hard recordable material set in the holding tray, when the holding tray is moved in a state in which the hard recordable material is set in the holding tray. Accordingly, it is possible to prevent the deterioration of the recording quality of the hard recordable material. Meanwhile, since both the first protrusion and the second protrusion are in the advanced state when the hard recordable material is set, the wrong insertion of the hard recordable material into the device body is prevented.

In the recording device, the flap may include a first protrusion provided in a passage region of the recordable material set in the holding tray and a second protrusion provided outside the passage region of the recordable material, and the length of the second protrusion may be greater than that of the first protrusion.

According to this aspect, since the length of the second protrusion outside of the passage region of the recordable material is set to be greater than that of the first protrusion in the passage region, only the second protrusion outside the passage region is brought into slidable contact with the holding tray and the first protrusion in the passage region is not brought into contact with the holding tray and the hard recordable material set in the holding tray, when the holding tray is moved in a state in which the hard recordable material is set in the holding tray. Accordingly, it is possible to prevent the deterioration of the recording quality of the hard recordable material. Meanwhile, since both the first protrusion and the second protrusion are in the advanced state when the hard recordable material is set, the wrong insertion of the hard recordable material into the device body is prevented.

In the recording device, the flap may have a plurality of protrusions arranged at an arrangement interval less than the dimension of the recordable material with a usable minimum size.

According to this aspect, currently, even when hard recordable materials such as CD-Rs or DVD-Rs with two sizes of diameter such as a diameter of 8 cm or a diameter of 12 cm are used, it is possible to prevent the wrong insertion into the device body. Accordingly, since a user may not be aware of the difference in size of the hard recordable material, usability is improved.

In the recording device, the advanced state of the second protrusion outside the passage region may be configured to become a tilted attitude in which the front end thereof is displaced in a direction in which the support frame is moved to the release position.

According to this aspect, if the front end of the wrong insertion preventive claw is brought into contact with another member, such as an ejection stacker, when the support frame is returned from the release position to the nip position, the rotation direction of the flap due to the contact becomes a constant direction. That is, the front end of the second protrusion is always rotated to the release position side. Accordingly, the operation for continuously transitioning the flap to the retreated state by the cam mechanism is stabilized.

In the recording device, the flap may include rotary shaft portions which are rotatably mounted at both ends thereof, and a deflection preventive portion which prevents the deflection of the flap in the retreated state.

According to this aspect, since the support points of the flap are increased to three points which includes both ends and another portion (intermediate point), the deflection of the flap is reduced. Accordingly, since a change in the amount of protrusion of the first protrusion and the second protrusion can be reduced, the operation of the wrong insertion preventive member is stabilized.

In the recording device, the deflection prevented unit may include an intermediate support portion which supports the flap at an intermediate portion of both ends.

In the recording device, the flap may have a protrusion of which an end is bent toward a side in which the recordable material is set.

According to this aspect, at the time of setting the hard recordable material, even when the holding tray is moved to an inner portion side such that the engagement state between the first protrusion and the second protrusion is released, the bent protrusion is hooked on the peripheral portion of the hard recordable material and thus the wrong insertion of the hard recordable material into the device body is prevented.

### BRIEF DESCRIPTION OF THE DRAWINGS

The invention will be described with reference to the accompanying drawings, wherein like numbers reference like elements.

FIG. 1 is a perspective view showing the internal structure of an ink jet printer.

FIG. 2 is a perspective view when a holding tray which is a transport device of a recordable material is positioned at a set position.

FIG. 3 is a perspective view showing a state in which a flap is engaged with an engaging receptacle.

FIG. 4 is a perspective view showing a state in which the flap is rotated by the movement of the holding tray in a transport direction.

FIG. 5 is a perspective view showing the holding tray.

FIG. 6 is a side cross-sectional view showing a position switching mechanism of a release mechanism.

FIGS. 7a-7c are an explanatory view showing the operation of the position switching mechanism of the release mechanism.

FIG. 8 is a perspective view showing a state in which a support frame, a support rod, and the flap are disassembled.

FIG. 9 is an enlarged perspective view of the left end portion of FIG. 8.

FIG. 10 is an enlarged perspective view of the intermediate portion of FIG. 8.

FIG. 11 is an enlarged perspective view of the right end portion of FIG. 8.

FIG. 12 is a perspective view showing the flap.

FIG. 13 is an enlarged perspective view showing the left end portion of the flap when viewed from a front surface side.

FIG. 14 is an enlarged perspective view showing the left end portion of the flap when viewed from a rear surface side.

FIG. 15 is an enlarged perspective view showing the right end portion of the flap when viewed from a front surface side.

FIG. 16 is an enlarged perspective view showing the right end portion of the flap when viewed from a rear surface side.

FIG. 17 is a perspective view showing a state in which an energizing spring is attached.

FIG. 18 is a side cross-sectional view of FIG. 17.

FIG. 19 is a perspective view showing the left end portion of the flap when the holding tray is positioned at a release position.

FIG. 20 is a perspective view showing the left end portion of the flap when the holding tray is positioned at a nip position.

FIG. 21 is a perspective view showing the right end portion of the flap when the holding tray is positioned at the release position.

FIG. 22 is a perspective view showing the right end portion of the flap when the holding tray is positioned at the nip position.

FIG. 23 is a perspective view showing a positional relationship between an ejection stacker and a tilted attitude when the flap protrudes.

FIG. 24 is a side cross-sectional view of a first protrusion having a short length according to another embodiment.

### DESCRIPTION OF EXEMPLARY EMBODIMENTS

Hereinafter, a recording device according to the invention will be described. The overall configuration of an ink jet printer 1 will be described with reference to the accompanying drawings, as a best embodiment for implementing the recording device of the invention.

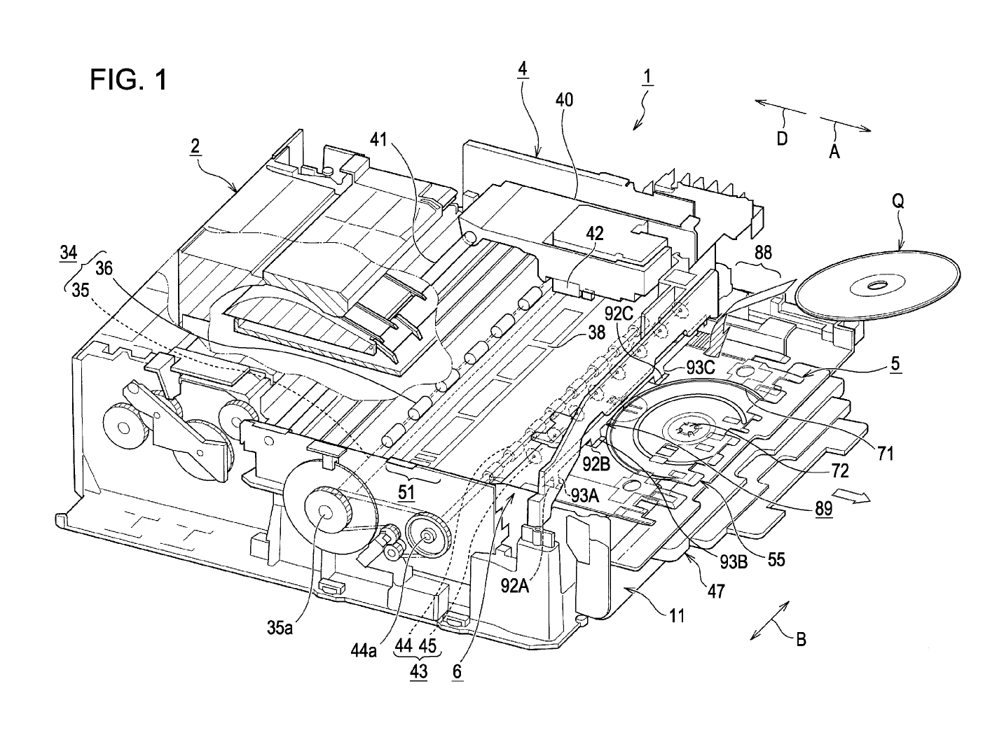

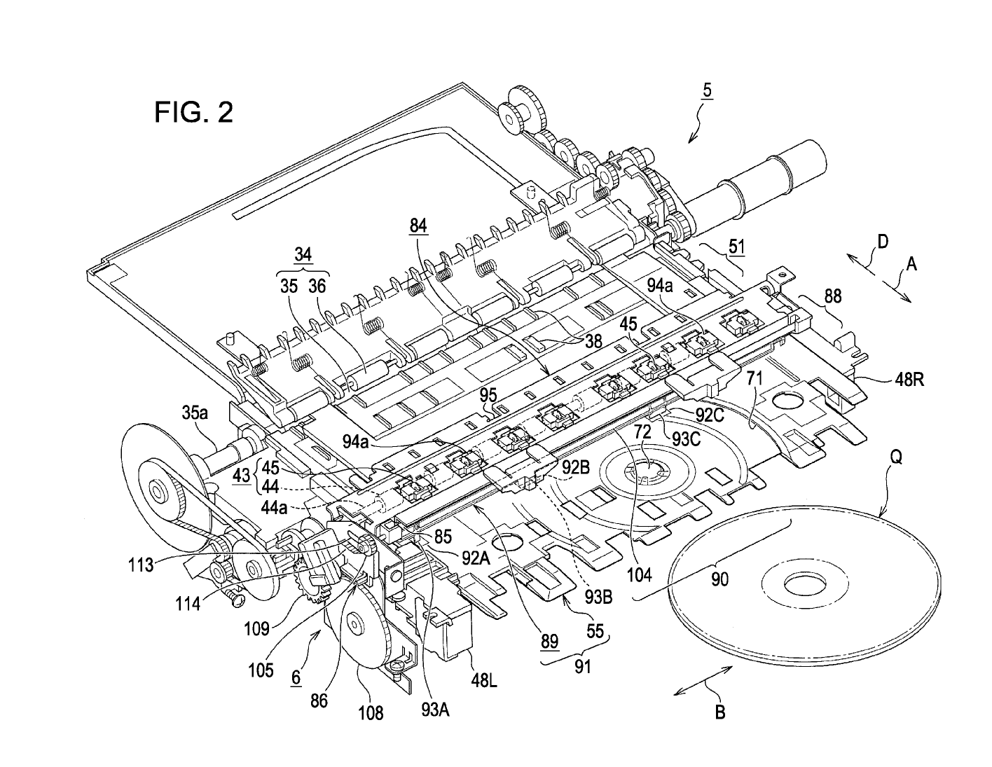

FIG. 1 is a perspective view showing the internal structure of the ink jet printer of the embodiment of the invention. FIG. 2 is a perspective view when a holding tray, which is a transport device of a recordable material, of the printer is positioned at a set position.

The ink jet printer 1 is a multifunction type ink jet printer in which an image reading device (scanner) (not shown) is mounted on the upper side thereof. In addition, the ink jet printer is an ink jet printer in which a holding tray 55 capable of performing recording with respect to both a soft recordable material having no self-standing, such as paper or a film and a hard recordable material Q having self-standing, such as an optical disc including a CD-R or a DVD-R, is built.

The ink jet printer 1 includes a printer body 2 which is a device body having a rectangular enclosure shape having relatively flat exterior surfaces. In addition, a feed cassette 11 in which a plurality of soft recordable materials is received in a stacked state is detachably mounted on the central lower portion of the front surface of the printer body 2. In addition, a sliding type ejection stacker 47 for stacking the soft recordable materials after recording is provided above the feed cassette 11.

In the printer body 2, a transport device 5 of a recordable material, which guides a soft recordable material fed from the feed cassette 11 and a hard recordable material Q set in the holding tray 55 to a recording region 51 (FIG. 2) and ejects them to the outside of the printer body 2 after recording, and a recording device 4 for performing desired recording with respect to the recordable material transported to the recording region 51 are provided.

The recording device 4 basically includes a platen 38 provided below the recording region 51, a recording head 42 provided above the recording region 51, and a carriage 40 for reciprocally moving the recording head 42 in a scanning direction B crossing a transport direction A of the recordable material. In addition, the platen 38 serves to support a recordable surface of the soft recordable material transported to the recording region 51 and the opposite surface thereof and define a gap with an ink ejection surface of the recording head 42. The recording head 42 is a member for ejecting inks of respective colors from nozzle holes formed in the ink ejection surface and performing recording with respect to the recordable surface of the recordable material.

The carriage 40 is a device for reciprocally scanning the recording head 42 and is a member which is reciprocally moved along a carriage guide shaft 41 in a scanning direction B by applying a transport force from an endless belt (not shown) thereto.

### Embodiment

Next, the detailed structure and the operation of the ink jet printer 1 according to the embodiment of the invention will be described with reference to the drawings.

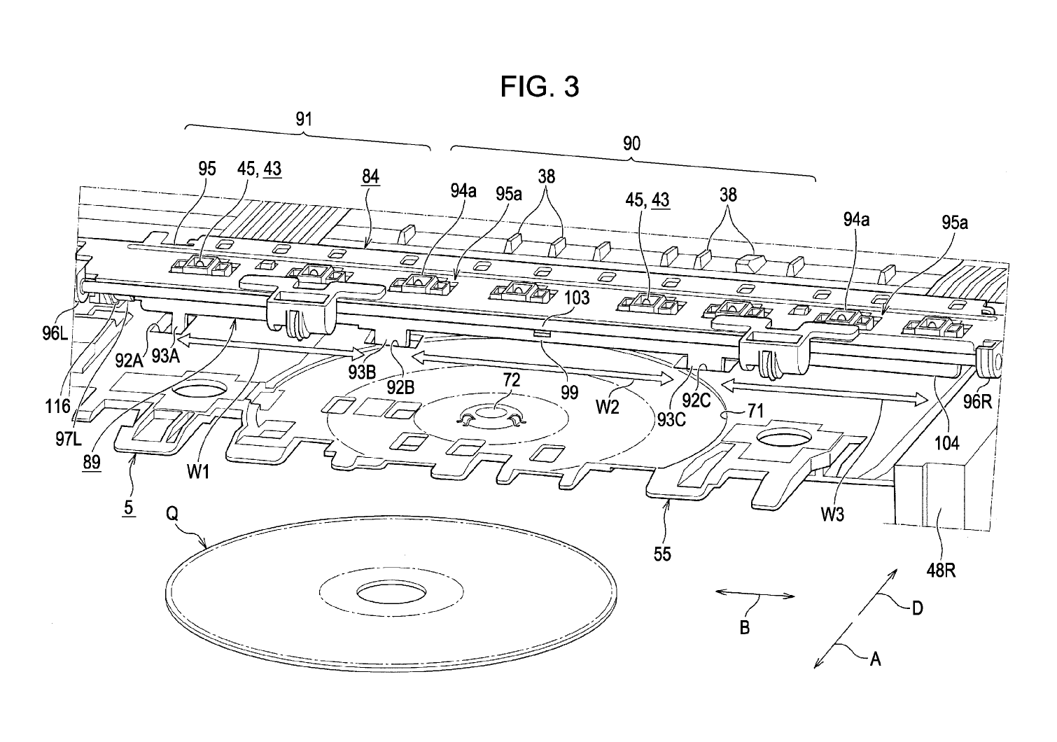

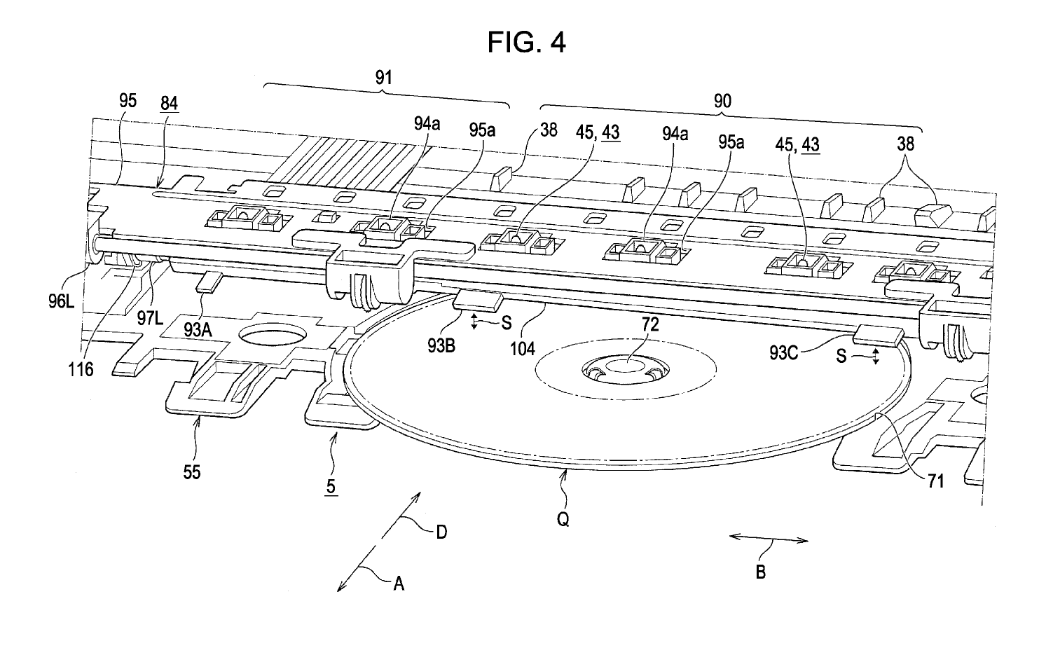

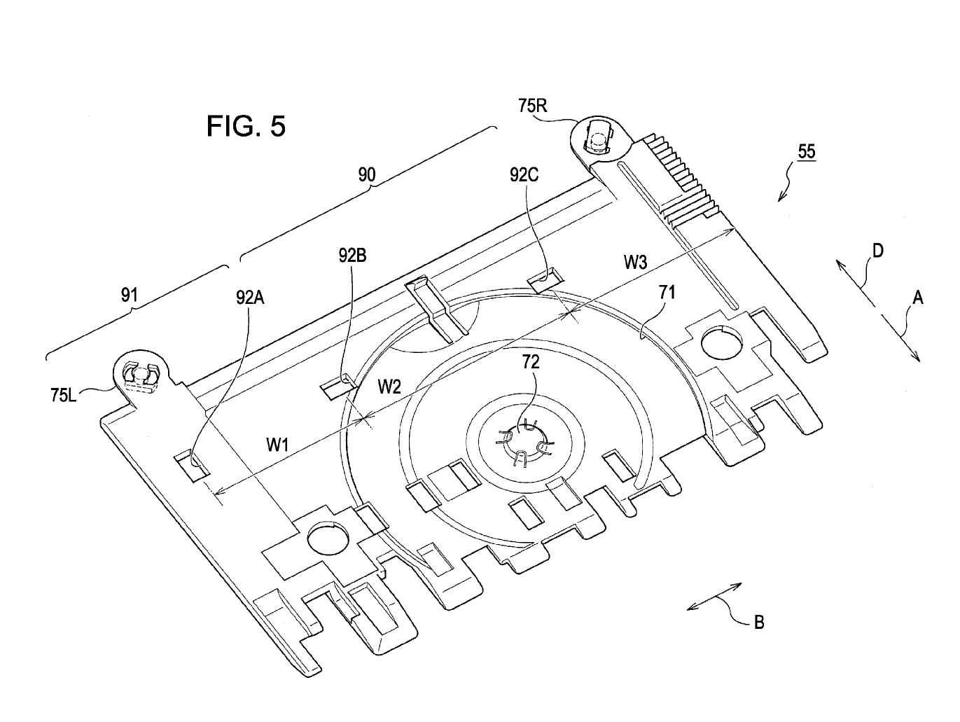

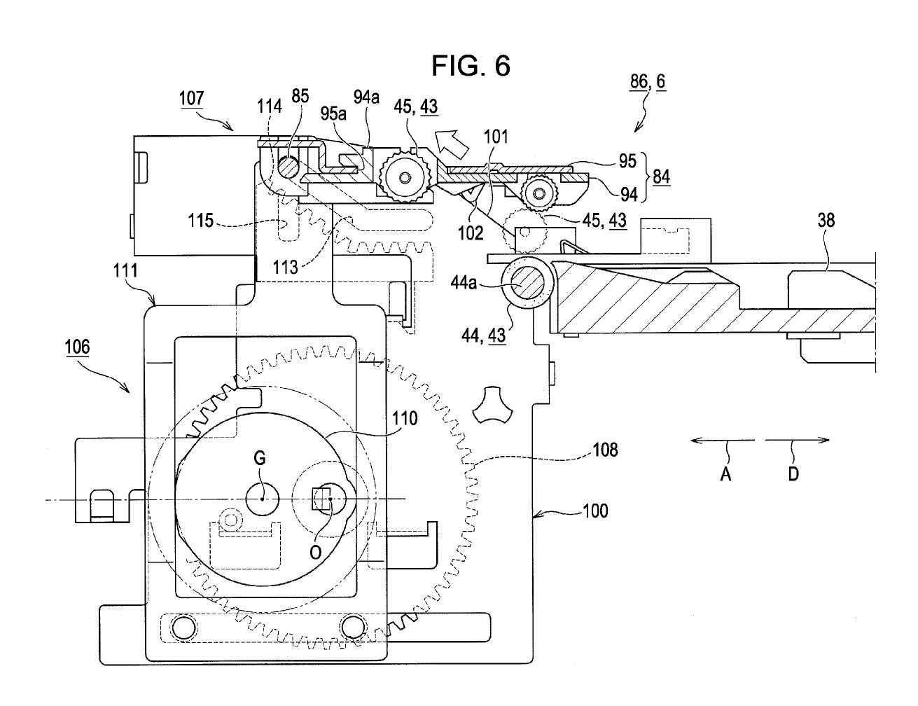

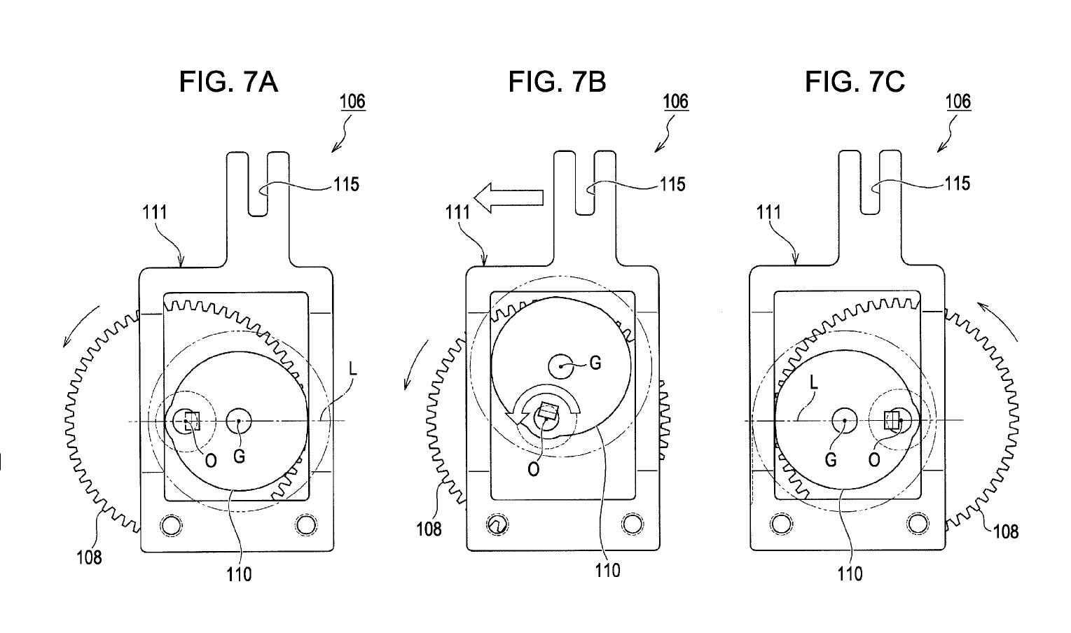

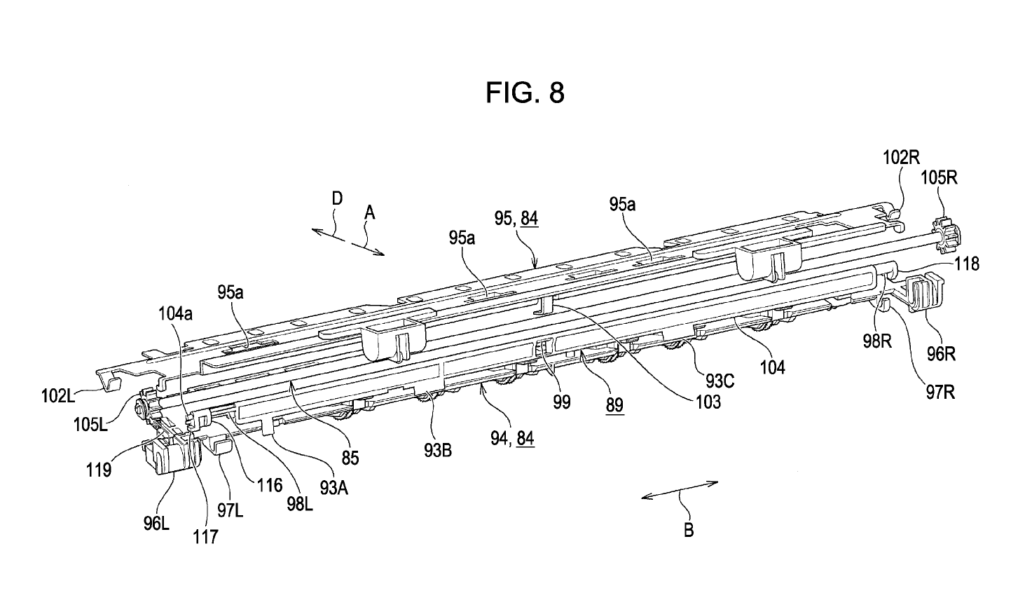

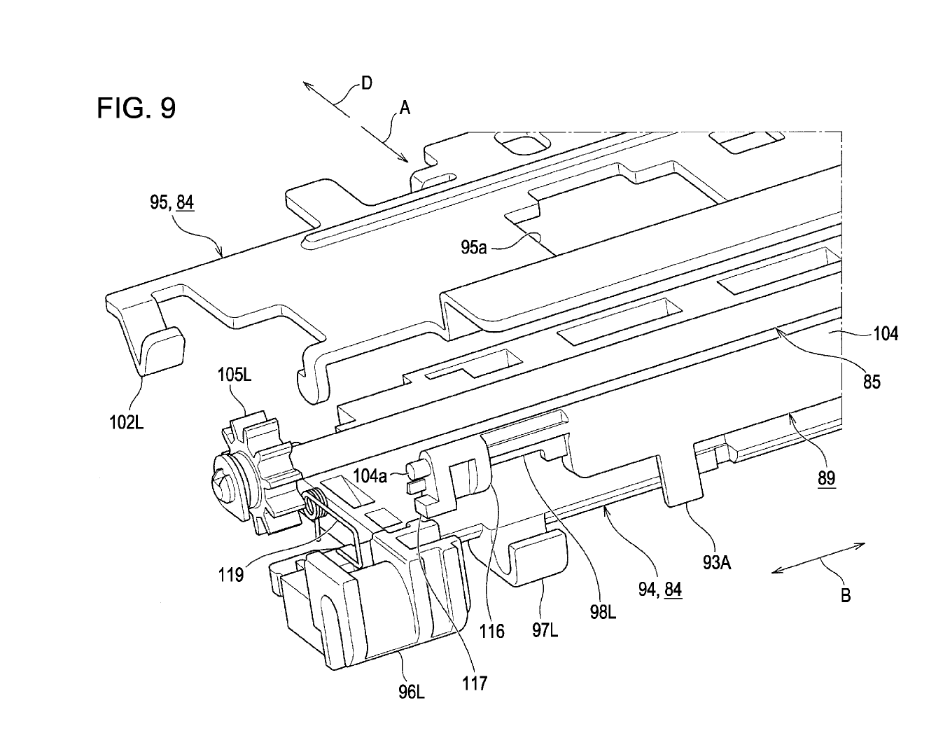

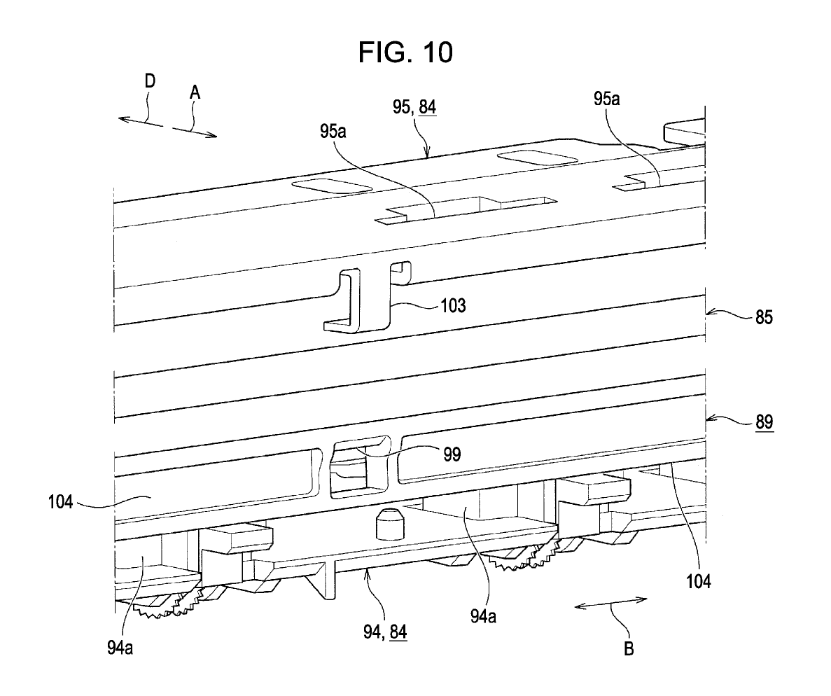

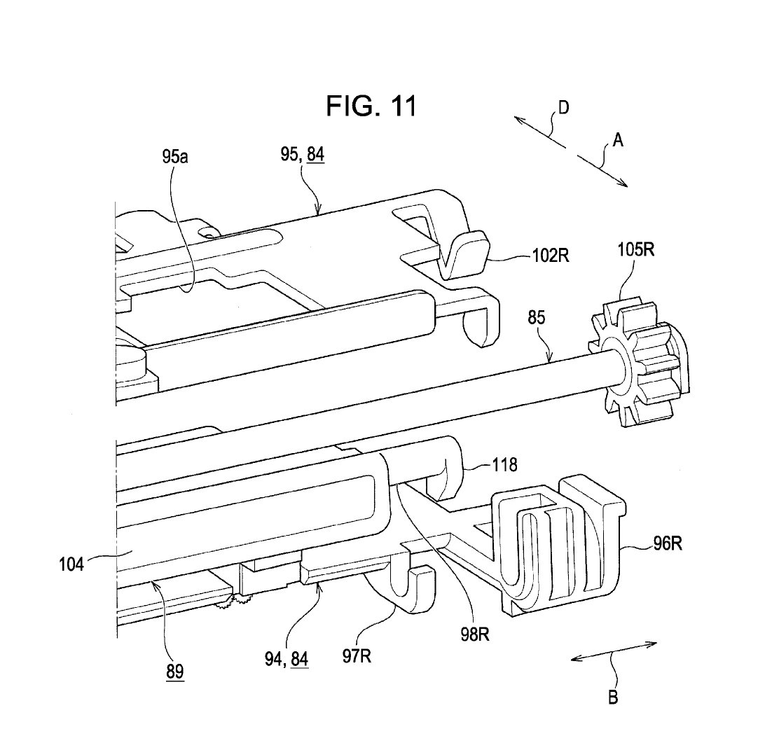

FIG. 3 is a perspective view showing a state in which a flap configuring a wrong insertion preventive member is engaged with an engaging receptacle. FIG. 4 is a perspective view showing a state in which the flap is rotated by the movement of the holding tray in a transport direction. FIG. 5 is a perspective view showing the holding tray. FIG. 6 is a side cross-sectional view showing a position switching mechanism of a release mechanism. FIGS. 7A, 7B and 7C are explanatory views showing the operation of the position switching mechanism of the release mechanism. FIG. 8 is a perspective view showing a state in which a support frame, a support rod, and the flap are disassembled. FIG. 9 is an enlarged perspective view of the left end portion of FIG. 8. FIG. 10 is an enlarged perspective view of the intermediate portion of FIG. 8. FIG. 11 is an enlarged perspective view of the right end portion of FIG. 8.

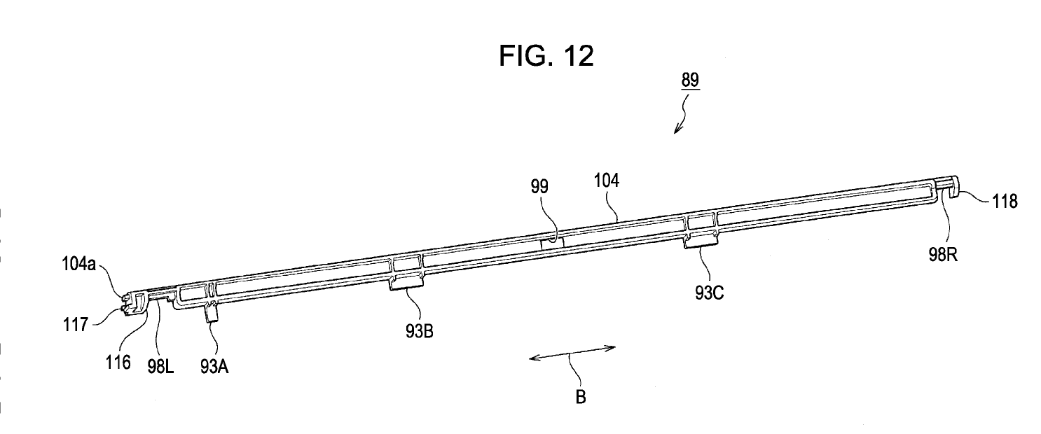

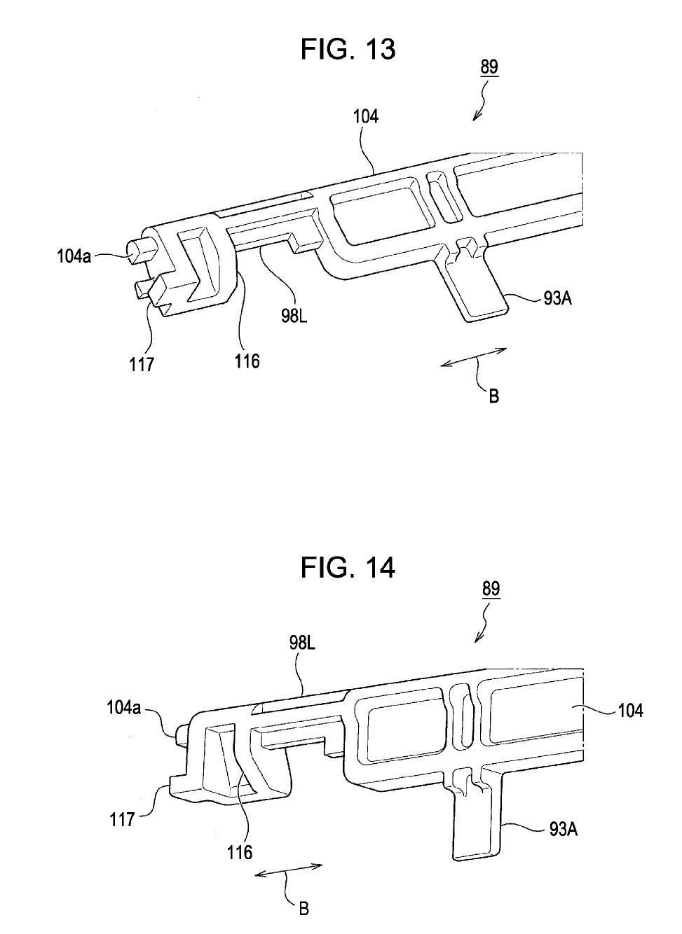

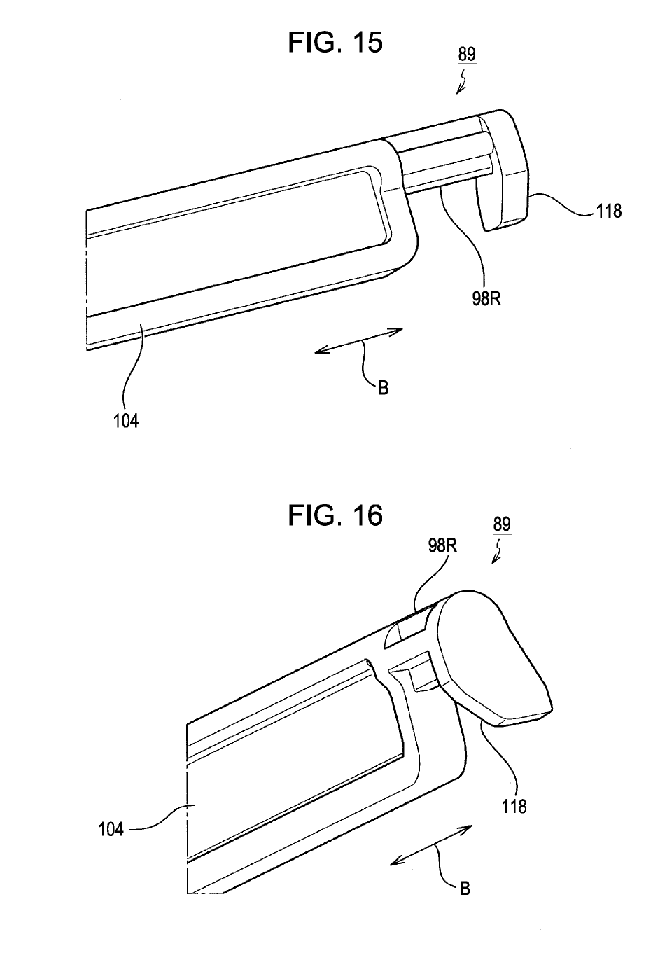

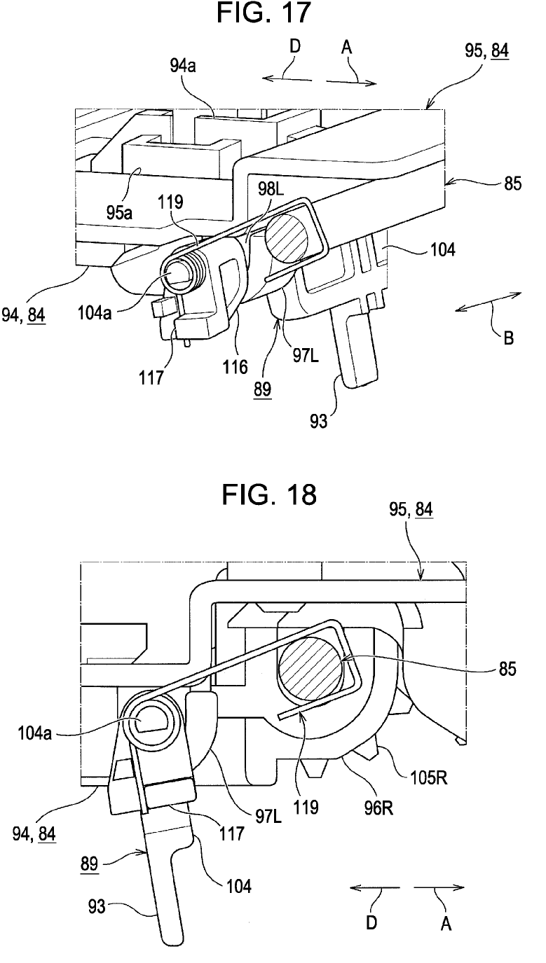

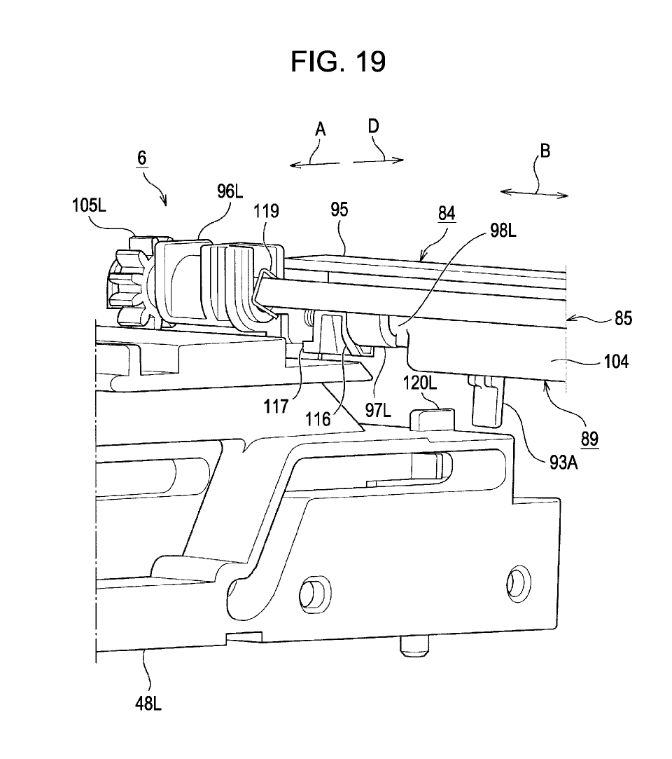

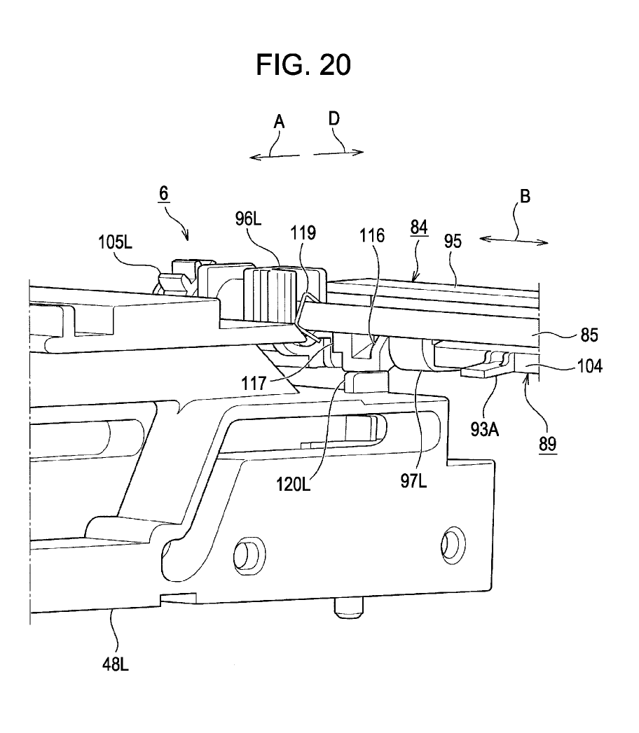

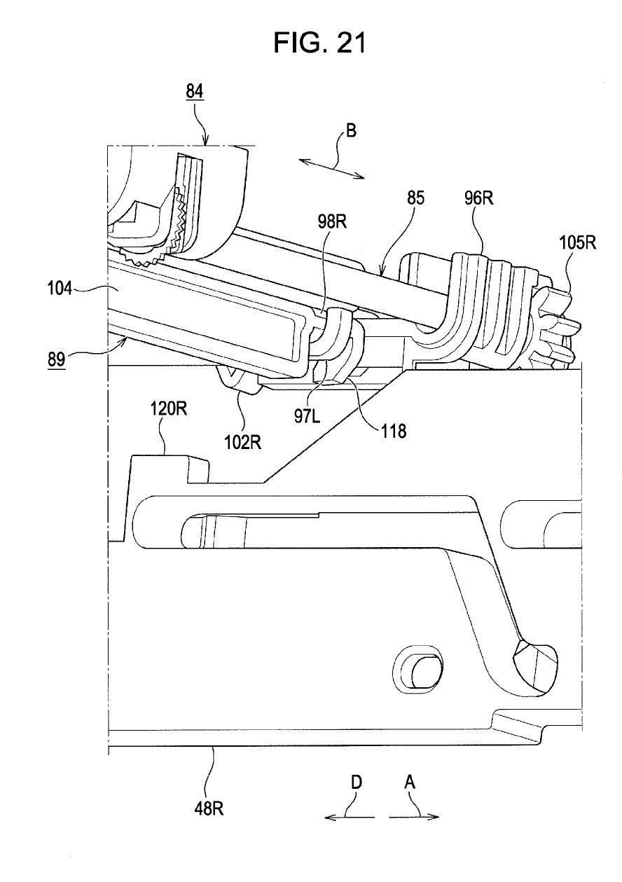

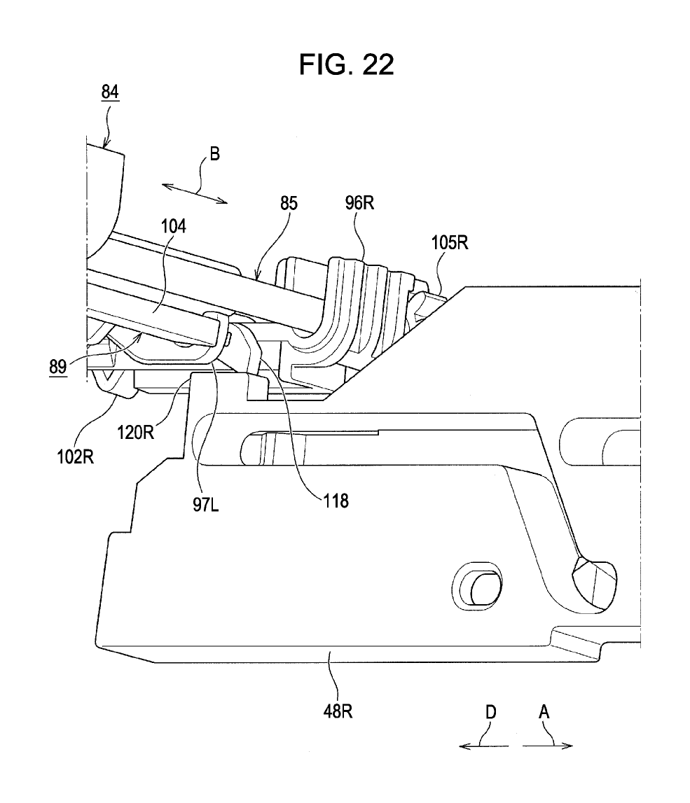

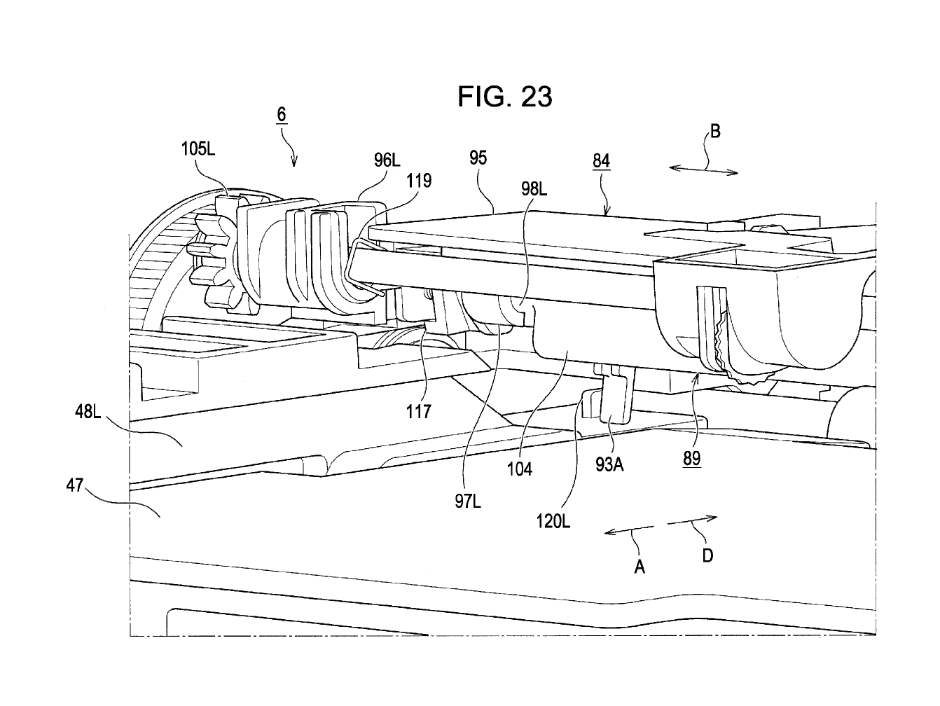

FIG. 12 is a perspective view showing the flap. FIG. 13 is an enlarged perspective view showing the left end portion of the flap when viewed from a front surface side. FIG. 14 is an enlarged perspective view showing the left end portion of the flap when viewed from a rear surface side. FIG. 15 is an enlarged perspective view showing the right end portion of the flap when viewed from a front surface side. FIG. 16 is an enlarged perspective view showing the right end portion of the flap when viewed from a rear surface side. FIG. 17 is a perspective view showing a state in which an energizing spring is attached. FIG. 18 is a partial side cross-sectional view of a portion to which the energizing spring is attached. FIG. 19 is a perspective view showing the left end portion of the flap when the holding tray is positioned at a release position. FIG. 20 is a perspective view showing the left end portion of the flap when the holding tray is positioned at a nip position. FIG. 21 is a perspective view showing the right end portion of the flap when the holding tray is positioned at the release position. FIG. 22 is a perspective view showing the right end portion of the flap when the holding tray is positioned at the nip position. FIG. 23 is a perspective view showing a positional relationship between an ejection stacker and a tilted attitude when the flap protrudes.

The transport device 5 of the recordable material of the present embodiment includes the holding tray 55 which is mounted in the printer body 2 and has a set concave portion 71 for holding a hard recordable material Q formed therein, a transport roller 34 which includes a transport driving roller 35 and pinches the transport driven roller 36 for pinching a hard recordable material Q together with the holding tray 55 or directly pinching a soft recordable material so as to apply a transport force to the recordable materials in a transport direction A and a return direction D, an ejection roller 43 which includes an ejection driving roller 44 and ejection driven roller 45 for directly pinching the soft recordable material after recording and ejecting the soft recordable material to the outside of the printer body 2, and a release mechanism 6 for moving the ejection driven roller 45 to a nip position in which the ejection driven roller abuts on the ejection driving roller 44 and moving the ejection driven roller to a release position in which the ejection driven roller separates from the ejection driving roller 44.

As the characteristic configuration of the invention, a flap 89 which is an example of a wrong insertion preventive member which advances into and retreats from a region 88 opposite to a surface (upper surface in the embodiment) in which the set concave portion 71 of the holding tray 55 is formed when the holding tray 55 is positioned at a set position in which the hard recordable material Q is set is provided.

As shown in FIG. 5, the holding tray 55 is, for example, a rectangular flat-plate-shaped member with a small depth, and includes the set concave portion 71 for setting the hard recordable material Q at a position close to the slightly front side of the central portion of the first surface (upper surface of the embodiment) of the holding tray 55 in a width direction B (the same reference numeral B as the scanning direction is used), and a chuck 72 for holding the hard recordable material Q set in the central portion thereof. In addition, as examples of the hard recordable material Q which may be set in the holding tray 55, various optical discs such as a CD-R, a CD-RW, a DVD-R, a DVD-RW or a blu-ray disc which has 12 cm or 8 cm in diameter, and which attracts attention as a next-generation optical disc, or a disc which will be developed in the future are applicable.

As shown in FIG. 5, connection pieces 75L and 75R for connecting two left and right guide arms (not shown) for expanding the movement stroke of the holding tray 55 are provided in the vicinities of the left and right corners of the rear end portion of the holding tray 55. A total of three rectangular hole-shaped engaging receptacles 92 including two engaging receptacles formed in a passage region 90 of the hard recordable material Q and one engaging receptacle formed in a left outer region 91 as an example of the passage region 90 are provided in the first surface of the holding tray 55 at positions on substantially the same straight line of the inner portion side of the set concave portion 71 with a predetermined arrangement interval W1, W2 and W3 in the width direction B of the holding tray 55.

In addition, when the three engaging receptacles 92 are distinguished, an engaging receptacle provided in the left outer region 91 is identified as 92A, an engaging receptacle provided on the left side of the passage region 91 is identified as 92B, and an engaging receptacle provided on the right side of the passage region 91 is identified as 92C. A second protrusion 93A and two first protrusions 93B and 93C of the flap 89 are engaged with the engaging receptacles 92A, 92B and 92C when the holding tray 55 is fully pulled out and positioned at the set position. In the length of the protrusions 93A, 93B and 93C, the engaging receptacle 92A of the outer region 91 is formed with the dimension of the depth direction slightly larger than that of the two engaging receptacles 92B and 92C of the passage region 90.

The release mechanism 6 includes a support frame 84 for rotatably supporting the ejection driven roller 45, a support rod 85 connected to the front end edge of the support frame 84 for delivering power to the support frame 84, and a position switching mechanism 86 for moving the support frame 84 between the nip position and the release position via the support rod 85 in a state of holding the horizontal attitude of the support frame 84.

The support frame 84 is a rectangular flat plate shaped member in plan view and has rigidity by overlapping a chassis portion 95 on the upper surface of a mold portion 94. A plurality of window portions 95a aligned in the width direction B is formed in the chassis portion 95, and roller holder portions 94a provided on the mold portion 94 respectively face the window portions 95a. The ejection driven roller 45 pivoted by a deflection deformable rod spring (not shown) is mounted in each of the roller holder portions 94a.

First bearing portions 96L and 96R for supporting the support rod 85 which are a support member and a support member of the support frame 84 are provided in, for example, the left and right corners of the front side of the mold portion 94. In addition, second bearing portions 97L and 97R which have a U-shape in a side view and support left and right rotary shaft portions 98L and 98R of the flap 89 are provided on the inside in the vicinities of the left and right first bearing portions 96L and 96R.

Contact pieces 102L and 102R which are brought into contact with guide slopes 101 formed in portions of the upper edge of a fixed frame 100, which is a member configuring the position switching mechanism 86 so as to hold the horizontal attitude of the support frame 84, and are bent in a V-shape in a side view are provided on the left and right ends of the chassis portion 95 so as to protrude downward. A hanging hook 103 which is bent in an L-shape in a side view so as to protrude downward is provided on an intermediate portion of the width direction B of the front end edge of the chassis portion 95, and is engaged with a deflection preventive engaging portion 99 provided on the intermediate portion of the width direction B of the flap 89 so as to regulate the deflection of a long flap frame 104 in the width direction B of the flap 89.

The support rod 85 is a rod-shaped member which is long in the width direction B and is rotatably supported by the first bearing portions 96L and 96R. Release pinions 105L and 105R which are members configuring the position switching mechanism 86 are provided on both ends of the support rod 85.

The position switching mechanism 86 includes a release shift mechanism 106 using a cam mechanism, and a release guide mechanism 107 for guiding the movement of the support frame 84 between the nip position and the release position.

The release shift mechanism 106 basically includes, as shown in FIGS. 2 and 6, a delivery gear 109 for delivering the rotation of a roller driving shaft 44a of the ejection driving roller 44 to an actuation gear 108 at the time of the operation, and the actuation gear 108 for delivering power delivered by the delivery gear 109 to a cam disk 110 provided at an eccentric position, a slide frame 111 which slides by the rotation of the cam disk 110 in a transport direction A and a return direction D of the holding tray 55, and the fixed frame 100 for rotatably supporting the actuation gear 108 and slidably holding the slide frame 111.

The release guide mechanism 107 includes a release guide groove 113 formed in the fixed frame 100 having a groove shape corresponding to the moving locus of the support frame 84, a rack 114 engaged with the release pinion 105 provided with respect to the fixed frame 100 along the release guide groove 113, and a U-shaped engaging groove 115 provided with respect to the slide frame 111, and the guide slope 101 formed in the portion of the upper edge of the fixed frame 100.

When power is delivered to the position switching mechanism 86 via the deliver gear 109, the actuation gear 108 rotates in a counterclockwise direction in FIG. 7, and rotates the cam disk 110 provided at the eccentric position G in the counterclockwise direction as shown in FIGS. 7A to 7C. The slide frame 111 is moved to the left side of the drawing by the rotation of the cam disk 110, the eccentric position G is moved to the left side of the rotation center O of the actuation gear 108 shown in FIG. 7C, and the rotation center 0 and the eccentric position G are positioned on the same straight line L.

In addition, by the movement of the slide frame 111, the support rod 85 engaged with the engaging groove 115 is guided by the release guide groove 113, the release pinion 105 and the rack 114 and is moved to the release position shown in FIG. 6. One end of the support frame 84 during moving is supported by the support rod 85, the horizontal attitude of the support frame is held by bringing the contact piece 102 into slidable contact with the guide slope 101 of the fixed frame 100, the support frame 84 is integral with the support rod 85 and the ejection driven roller 45, and is moved from the nip position denoted by a virtual line (two-dot chain line) of FIG. 6 to the release position denoted by a solid line of FIG. 6 while holding the horizontal attitude.

Although not shown, by rotating the ejection driving roller 44 in a reverse direction, the support frame 84 is integrally moved in the reverse direction with the support rod 85 and the ejection driven roller 45 and is moved from the release position denoted by the solid line of FIG. 6 to the nip position denoted by the virtual line of FIG. 6 while holding the horizontal attitude.

The flap 89 includes the long rod-shaped flap frame 104 in which the rotary shaft portions 98L and 98R are rotatably connected to the second bearing portions 97L and 97R, and the second protrusion 93A and the two first protrusions 93B and 93C provided on the flap frame 104 at a proper interval in the width direction B. When the support frame 84 is positioned at the nip position, the flap 89 is in a retreated state shown in FIG. 20 so as to allow the passage of the soft recordable material and, when the support frame 84 is positioned at the release position, the flap 89 is in an advanced state shown in FIG. 19 so as to prevent the wrong insertion of the hard recordable material Q.

As shown in FIGS. 12 to 16, the flap frame 104 is a rod-shaped member which is long in the width direction B of the holding tray 55, the rotary shaft portions 98L and 98R are provided at both the left and right ends thereof, and the deflection preventive engaging portion 99 forming a rectangular hole-shaped deflection preventive portion is provided in the intermediate portion of the width direction B of the flap frame 104. A first cam 116 which is brought into contact with a projection 120L formed on the upper surface of a left stacker base 48L of a support guide member of the ejection stacker 47 so as to hold the retreated attitude of the flap 89 and a spring peg portion 117 for the energizing spring 119 configured by a torsion coil spring, as an example of a unit for energizing the second protrusion 93A and the two first protrusions 93B and 93C to always take the advanced attitude, are provided outside the rotary shaft portion 98L on the left end of the flap frame 104.

A second cam 118, which is brought into contact with the projection 12OR formed on the upper surface of a right stacker base 48R so as to hold the retreated attitude of the flap 89 together with the first cam 116, is provided outside the rotary shaft portion 98R on the right end of the flap frame 104. In addition, the three protrusions 93A, 93B and 93C are provided at the proper interval in the width direction B of the flap frame 104, and the protrusions 93A, 93B and 93C include the second protrusion 93A positioned in the left outer region 91 as an example of the passage region 90 of the hard recordable material Q set in the set concave portion 71 and the two first protrusions 93B and 93C positioned in the passage region 90, as described above.

The actuation length of the second protrusion 93A positioned in the outer region 91 is set to be greater than that of the first protrusions 93B and 93C positioned in the passage region 90, and, as shown in FIG. 4, the two first protrusions 93B and 93C on the inside float from the recordable surface of the hard recordable surface Q in a state in which the second protrusion 93A on the outside is in contact with the outer region 91 of the holding tray 55 so as to form a gap S therebetween.

The three protrusions 93A, 93B and 93C are configured so as to be engaged with the three engaging receptacles 92A, 92B and 92C formed in the first surface of the holding tray 55 when the holding tray 55 is positioned at the set position. Accordingly, even when a portion of the periphery of the hard recordable material Q is brought into contact with any one of the protrusions 93A, 93B and 93C when setting the hard recordable material Q, the protrusions 93A, 93B and 93C butt the rear end edge of the engaged engaging receptacle 92 so as to prevent further rotation and thus the wrong insertion of the hard recordable material Q is prevented with certainty.

The arrangement interval W of the width direction B of the holding tray 55 of the three protrusions 93A, 93B and 93C is set to an interval for disallowing a hard recordable material Q having a usable minimum size (8 cm, currently) to advance into the printer body 2. Accordingly, the arrangement intervals W1, W2 and W3 denoted by the arrows of FIG. 3 are set to be less than the diameter of the hard recordable material Q having the minimum size.

As shown in FIG. 23, the advanced attitude of at least the second protrusion 93A provided in the outer region 91 out of the protrusions 93A, 93B and 93C is set to become the tilted attitude in which the front end thereof is slightly displaced in the transport direction A of the holding tray 55. In addition, by this configuration, when the support frame 84 is returned from the release position to the nip position, the direction of the rotation of the flap 89 generated by bringing the front ends of the protrusions 93A, 93B and 93C into contact with the ejection stacker 47 becomes a constant direction, that is, it is always in the direction of the set side of the hard recordable material Q (release direction) in the present embodiment. Accordingly, the operation for transitioning the flap 89 to the advanced attitude or the retreated attitude is stabilized and is performed with certainty.

As shown in FIGS. 17 and 18, the energizing spring 119 is attached by inserting a coil portion into a mounting shaft portion 104a provided on the left end of the flap frame 104, supporting one end of the energizing spring 119 by the spring peg portion 117 and fitting a U-shaped bent end of the energizing spring 119 to the support rod 85. The flap 89 is always energized by the energizing spring 119 to the rotated attitude associated with the advanced state and is configured so as to be rotated using the advanced attitude as a neutral point in both the transport direction A and the return direction D of the holding tray 55 in a range in which the protrusions 93A, 93B and 93C can be rotated.

Next, the operation of the recording device of the invention having the above-described configuration will be described in a state of dividing a situation into (1) a situation just before arrival, in which the holding tray 55 arrives at the set position, (2) a situation at the time of arrival, in which the holding tray 55 arrives at the set position, (3) a situation just after movement, in which the holding tray 55 starts to be moved from the set position to a recording starting position, (4) a situation at the time of nip, in which the support frame 84 is positioned at the nip position, and (5) a situation at the time of release, in which the support frame 84 is positioned at the release position.

### (1) Situation Just Before Arrival (See FIG. 4)

When recording is performed with respect to the hard recordable material Q, the ejection driven roller 45 is positioned at the release position such that the ejection driven roller 45 is not brought into contact with the holding tray 55 or the hard recordable material Q set in the holding tray 55. In this state, the flap 89 is held in the advanced attitude while being able to be rotated in the transport direction A and the return direction D by the energizing force of the energizing spring 119. The front end of the holding tray 55 is first brought into contact with the second protrusion 93A positioned in the outer region 91 and the second protrusion 93A is in the tilted attitude in which the front end is displaced in the transport direction A.

When the holding tray 55 is further moved in the transport direction A, the second protrusion 93A is brought into slidable contact with the outer region 91 of the first surface of the holding tray 55 in a state of holding the tilted attitude. In addition, since the actuation length of the two first protrusions 93B and 93C of the passage region 90 is less than that of the second protrusion 93A and the deflection preventive engaging portion 99 is held by the hanging hook 103, the first protrusions float from the first surface of the holding tray 55 by the gap S.

Accordingly, as shown in FIG. 4, even when the hard recordable material Q is set in the set concave portion 71, since the two first protrusions 93B and 93C are not brought into contact with the recordable surface of the hard recordable material Q, the recordable surface is not damaged.

### (2) Situation at the Time of Arrival (See FIG. 3)

When the holding tray 55 arrives at the set position, the three protrusions 93A, 93B and 93C are engaged with the engaging receptacles 92A, 92B and 92C, respectively. When the hard recordable material Q is set in the set concave portion 71 of the holding tray 55 in this state, even when the hard recordable material is wrongly inserted into another place, since the rotation of the protrusions 93A, 93B and 93C in the return direction D is regulated by the engagement of the three protrusions 93A, 93B and 93C and the engaging receptacles 92A, 92B and 92C, the wrong insertion of the hard recordable material Q is prevented. Since the arrangement intervals W1, W2 and W3 of the three protrusions 93A, 93B and 93C are set to be less than the diameter of the hard recordable material Q with the usable minimum size as described above, the wrong insertion of all sizes of hard recordable materials Q into the printer body 2 is prevented with certainty.

### (3) Situation Just After Movement (See FIG. 4)

When the holding tray 55 positioned at the set position starts to be moved toward a recording position or a storage position, the three protrusions 93A, 93B and 93C are retreated from the engaging receptacles 92A, 92B and 92C, respectively. The second protrusion 93A positioned at the outer region 91 is in the tilted attitude in which it is displaced in the return direction D opposite to FIG. 4 in a state in which the front end thereof is in contact with the first surface of the holding tray 55.

At this time, since the actuation length of the two first protrusions 93B and 93C of the passage region 90 is less than that of the second protrusion 93A of the outer region 91 and the deflection preventive engaging portion 99 is held by the hanging hook 103, the first protrusions float from the first surface of the holding tray 55 by the gap S, similar to (1) the situation just before arrival. Accordingly, since the two first protrusions 93B and 93C are not brought into contact with the recordable surface of the hard recordable material Q set in the set concave portion 71 of the holding tray 55, the holding tray 55 is smoothly transported without causing the set deviation of the hard recordable material Q.

### (4) Situation at the Time of Nip (See FIGS. 20 and 22)

When recording is performed with respect to the soft recordable material, the holding position 55 is positioned at the storage position and the release mechanism 6 is actuated so as to move the support frame 84 to the nip position. At this time, the ejection driven roller 45, the support rod 85 and the flap 89 are integrally moved to the nip position. The first cam 116 and the second cam 118 of the flap 89 are brought into contact with the left and right projections 120L and 120R provided on the left and right stacker bases 48L and 48R during moving and the flap 89 is rotated in the transport direction A against the energizing force of the energizing spring 119.

When the support frame 84 arrives at the nip position, the flap 89 is in the retreated attitude in which the protrusions 93A, 93B and 93C protrude horizontally such that the soft recordable material is transmitted.

### (5) Situation at the Time of Release (See FIGS. 19 and 21)

When recording is performed with respect to the hard recordable material Q, the release mechanism 6 is actuated so as to move the support frame 84 to the release position, in order to allow the holding tray 55 to be moved between the storage position and the set position. At this time, the ejection driven roller 45, the support rod 85 and the flap 89 are integrally moved to the release position. In this state, the energizing force of the energizing spring 119 is applied such that the flap 89 is in the advanced attitude in which the front ends of the protrusions 93A, 93B and 93C are slightly displaced in the transport direction A.

When the holding tray 55 is brought into contact with the second protrusion 93A of the outer region 91 in this state, the flap 89 is rotated in the transport direction A or the return direction D against the energizing force of the energizing spring 119, as described above, so as to move the holding tray 55. Meanwhile, in a state in which the holding tray 55 arrives at the set position, the wrong insertion of the hard recordable material Q into the printer body 2 is prevented with certainty by the engagement of the protrusions 93A, 93B and 93C and the engaging receptacle 92, as described above.

### Other Embodiments

Although the recording device 1 of the invention basically has the above-described configuration, the configuration may be partially modified or omitted without departing from the scope of the invention.

For example, the wrong insertion preventive member is not limited to the rotary flap 89 and various wrong insertion preventive members with different configurations in a vertical slide shutter structure, or the like, may be employed. The wrong insertion preventive member may be attached to a member provided in a fixed state, such as the printer body 2, in addition to a movable member such as the support frame 84.

The number of protrusions 93A, 93B and 93C provided on the flap frame 104 is not limited to three as shown, the number of protrusions 93A, 93B and 93C may be increased to four or more or decreased by increasing the width dimension of the protrusions 93A, 93B and 93C. The shape of the engaging receptacle 92 is not limited to the rectangular hole shape in which the front and rear surfaces of the holding tray 55 are penetrated as shown, and the engaging receptacle 92 with a concave portion having a predetermined depth or a slit or a cut shape may be used.

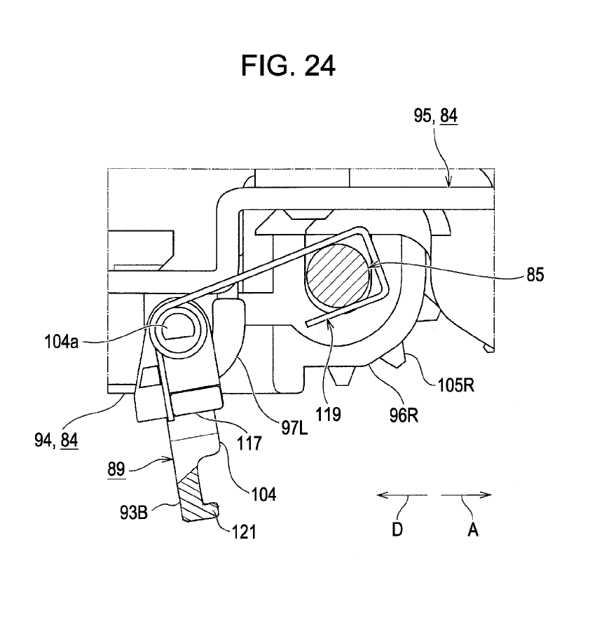

As shown in FIG. 24, a hook portion 121 protruding to the set side of the hard recordable material Q may be integrally molded or attached on the front end of the short first protrusion 93B and/or 93C. In addition, if the hook portion 121 is provided, even when the holding tray 55 is moved to the inner portion side such that the engagement state of the protrusions 93A, 93B and 93C and the engaging receptacle 92 is released at the time of setting the hard recordable material Q, the hook portion 121 of the front end of the short first protrusion 93B and/or 93C is hooked on the peripheral portion of the hard recordable material Q such that the wrong insertion of the hard recordable material Q into the printer body 2 is prevented.

What is claimed is:

1. A recording device comprising:
a holding tray which is reciprocally transported so as to be positioned at a set position for setting a recordable material and another position;
a transport roller which applies transport force to the holding tray; and
a wrong insertion preventive member of the recordable material, which is provided so as to advance into or retract from the holding tray in a region facing a surface of the holding tray, on which the recordable material is set, when the holding tray is positioned at the set position.

2. The recording device according to claim 1, further comprising:
an ejection roller including an ejection driving roller and an ejection driven roller and the application of an ejection force to another recordable material after recording;
a support frame which rotatably supports the ejection driven roller; and
a release mechanism which moves the support frame to a nip position in which the ejection driven roller is brought into contact with the ejection driving roller and a release position in which the ejection driven roller is separated from the ejection driving roller,
wherein the wrong insertion preventive member is in a retreated state when the support frame is positioned at the nip position and is in an advanced state when the support frame is positioned at the release position, where it interlocks with the operation of the release mechanism.

3. The recording device according to claim 2, wherein the wrong insertion preventive member includes a flap which is rotatably mounted in the support frame by a cam mechanism, and the cam mechanism is interlocked with the operation of the release mechanism such that the flap is in a retreated attitude when the support frame is positioned at the nip position and is in an advanced attitude when the support frame is positioned at the release position.

4. The recording device according to claim 1, wherein an engaging receptacle engaged with the wrong insertion preventive member in the advanced state is provided in the holding tray, when the holding tray is positioned at the set position.

5. The recording device according to claim 1, wherein:
the wrong insertion preventive member includes a flap which advances into and retreats from the holding tray by rotation, and
the flap is energized such that a rotation attitude associated with the advanced state is held and is configured so as to be rotated using the attitude as a neutral point.

6. The recording device according to claim 5, wherein:
the flap includes a first protrusion provided in a passage region of the recordable material set in the holding tray and a second protrusion provided outside the passage region of the recordable material, and
the flap is tilted from the neutral point by the contact between the holding tray and the second protrusion such that the first protrusion is separated from the recordable material.

7. The recording device according to claim 5, wherein:
the flap includes a first protrusion provided in a passage region of the recordable material set in the holding tray and a second protrusion provided outside the passage region of the recordable material, and
the length of the second protrusion is greater than that of the first protrusion.

8. The recording device according to claim 5, wherein the flap has a plurality of protrusions arranged at an arrangement interval less than the dimension of the recordable material with a usable minimum size.

9. The recording device according to claim 5, wherein the advanced state of the second protrusion outside the passage region is configured to become a tilted attitude in which the front end thereof is displaced in a direction in which the support frame is moved to the release position.

10. The recording device according to claim 5, wherein the flap includes rotary shaft portions which are rotatably mounted at both ends thereof, and a deflection preventive portion which prevents the deflection of the flap in the retreated state.

11. The recording device according to claim 10, wherein the deflection prevented unit includes an intermediate support portion which supports the flap at an intermediate portion of both ends.

12. The recording device according to claim 5, wherein the flap has a protrusion of which an end is bent toward a side in which the recordable material is set.
